(19) United States
(12) Patent Application Publication
(10) Pub. No.: US 2010/0227304 A1
(43) Pub. Date: Sep. 9, 2010

(54) VIRTUAL SCHOOL SYSTEM AND SCHOOL CITY SYSTEM

(75) Inventor: Naoto Horikawa, Osaka (JP)

Correspondence Address: Rahman LLC, 10025 Governor Warfield Parkway, Suite 110, Columbia, MD, 21044, US

(73) Assignee: KABUSHIKI KAISHA SRJ, Tokyo (JP)

(21) Appl. No.: 12/162,010

(22) PCT Filed: Dec. 28, 2007
(86) PCT No.: PCT/JP2007/075282

§ 371 Date: Jul. 24, 2008

(30) Foreign Application Priority Data
Nov. 26, 2007 (JP) 2007-009089

(51) Int. Cl. G09B 5/00

(52) U.S. Cl. 434/350; 434/307 R; 434/309

(57) ABSTRACT

A virtual school system includes a school management side system with a teacher's terminal and a server computer connected to the teacher's terminal by way of LAN, and a student side system including a plurality of student's terminals connected to the server computer by way of Internet.

### CROSS REFERENCE TO RELATED APPLICATION

This application claims the benefit of International Application No. PCT/JP2007/075282, filed on Dec. 28, 2007 and Japanese Patent Application No. 2007-009089U, filed on Nov. 26, 2007, the complete disclosures of which, in their entireties, are herein incorporated by reference.

### TECHNICAL FIELD

The present invention relates to education systems that use networks, in particular, to an education system that allows students to carry out education and communication in real time and on demand.

### BACKGROUND ART

As an education system using Internet of the prior art, an education system is disclosed in which a virtual school is built on the Internet so that each student admitted to the school can attend lectures while being at home. For instance, an education system is disclosed that enables each student to learn by having each student's terminal log into the server of the school management side system through the Internet, and receive provision of educational material content from the server (see Japanese Unexamined Patent Publication No. 2000-172161, Japanese Unexamined Patent Publication No. 2001-305940). In such education system, a main display region and a sub-display region are arranged on the display of each student's terminal, where an educational material content and a student image are displayed on the main display region and the sub-display region, respectively.

### DISCLOSURE OF INVENTION

In such education system of the prior art, however, problems are found in motivating the student and in continuity of learning.

It is an object of the present invention to provide a virtual school system and a school city system in which classes are organized with students having the same goal, and a homeroom class and a place to exchange other information are created to provide a sense of reality as if taking classes in school thereby leading to motivating of the student and continuity of learning.

A virtual school system relates to a virtual school system including a school management side system including a teacher's terminal and a server computer connected to the teacher's terminal by way of a first network; and a student side system including a plurality of student's terminals connected to the server computer by way of a second network; wherein the teacher's terminal includes a teacher's personal computer, a teacher's camera, connected to the teacher's personal computer, for imaging a teacher, a teacher's microphone, connected to the teacher's personal computer, for inputting voice, and a teacher's speaker, connected to the teacher's personal computer, for outputting voice; the each student's terminal includes an each student's personal computer, an each student's camera, connected to the each student's personal computer, for imaging each student, an each student's microphone, connected to the each student's personal computer, for inputting each voice, and an each student's speaker, connected to the each student's personal computer, for outputting each voice; the teacher's personal computer includes a teacher image transmitting unit for transmitting an image of the teacher imaged by the teacher's camera to the server computer via the first network, and a teacher voice transmitting unit for transmitting the voice of the teacher input to the teacher's microphone to the server computer via the first network; the each student's personal computer includes an each student information transmitting unit for transmitting identification information of each student in correspondence to each student password to the server computer via the second network, an each student image transmitting unit for transmitting the image of each student imaged by the each student's camera to the server computer via the second network, an each student voice transmitting unit for transmitting the voice of each student input to the each student's microphone to the server computer via the second network; an each student display unit with a main display region and a sub-display region, and an each student display control unit for controlling the each student display unit; the server computer includes a database server, stored in advance with identification information of each student in association with the each student password, for cross checking the identification information received from the each student information transmitting unit and the identification information stored in advance, and an application server for receiving the image and the voice of each student from the each student image transmitting unit and the each student voice transmitting unit, receiving the image and the voice of the teacher from the teacher image transmitting unit and the teacher voice transmitting unit based on the cross check result by the database server, controlling the each student display control unit and the each student's speaker via the second network, displaying the received image of the teacher and the image of each student on the main display region and the sub-display region, respectively, and outputting the received image of the teacher and the image of each student to the each student's speaker; the each student's personal computer includes each student request transmitting unit for receiving a display change request by operation of each student, and transmitting the display change request to the application server via the second network; and the application server displays the image of the corresponding student on the main display region and displays the image of another student on the sub-display region when receiving the display change request from one of the each student request transmitting unit. The classes can be organized with students having the same goal compared to the conventional education system (e.g., e-learning) which has problems in motivating of the student and continuity of learning. The above described problem can be solved by providing a mechanism enabling students to compete and support each other, and the learning goal can be achieved.

In the virtual school system, each student's personal computer includes each access request transmitting unit for receiving an access request by operation of each student and transmitting the access request to the server computer via the second network; and the server computer includes a web server, storing a homepage of the school management side in advance, for controlling the each student display control unit via the second network and displaying the homepage on the each student display unit when receiving each access request from the each access request transmitting unit.

In the virtual school system, each student's personal computer includes each question request transmitting unit for receiving a question request by operation of each student, and transmitting the question request to the application server via the second network; and the application server controls the corresponding each student display control unit when receiving the question request, and displays the image of the teacher and a question accepting image on the main display region and the sub-display region, respectively.

In the virtual school system, identification information is at least one of student ID, preferred school of each student, membership number, sex, name (handle name), name of enrolled junior high school or high school, grade, age, scholastic ability of various subjects, with respect to junior high school student, high school student, college student, and working people. Through the use of such identification information, communication (such as homeroom, counseling, and learning advice) between the teacher and the student or between students among various grades and ages, or communication between the students can be realized, and festivals and events by the entire school can be performed. In various qualification acquisition courses for working people etc., a function of receiving learning advice and counseling on students of higher class to students of lower class assuming a collective of classes (by scholastic level) is mounted.

In a school city system, a plurality of virtual school systems are arranged. According to such configuration, “school city system” or a mechanism networking the “collection of virtual schools” can be built with “virtual school” positioned as one form. Each school is collected in the “school city system”, and networking of not only students but with various sites (e.g., such as qualification acquisition, language, and examination) can be incorporated.

### BRIEF DESCRIPTION OF DRAWINGS

FIG. 1 is a block diagram showing a first embodiment of a virtual school system of the present invention.

FIG. 2 is a block diagram showing details of a student's personal computer.

FIG. 3 is a block diagram showing details of a teacher's personal computer.

FIG. 4 is a flowchart showing a display operation according to the first embodiment of the virtual school system.

FIG. 5 is a flowchart showing the display operation according to the first embodiment of the virtual school system.

FIG. 6 is a flowchart showing the display operation according to the first embodiment of the virtual school system.

FIG. 7 shows one example of an image displayed on a display.

FIG. 8 shows one example of an image displayed on the display.

FIG. 9 is a flowchart showing a display operation according to a second embodiment of the virtual school system of the present invention.

FIG. 10 shows one example of an image displayed on the display.

FIG. 11 is a block diagram showing one embodiment of a school city system of the present invention.

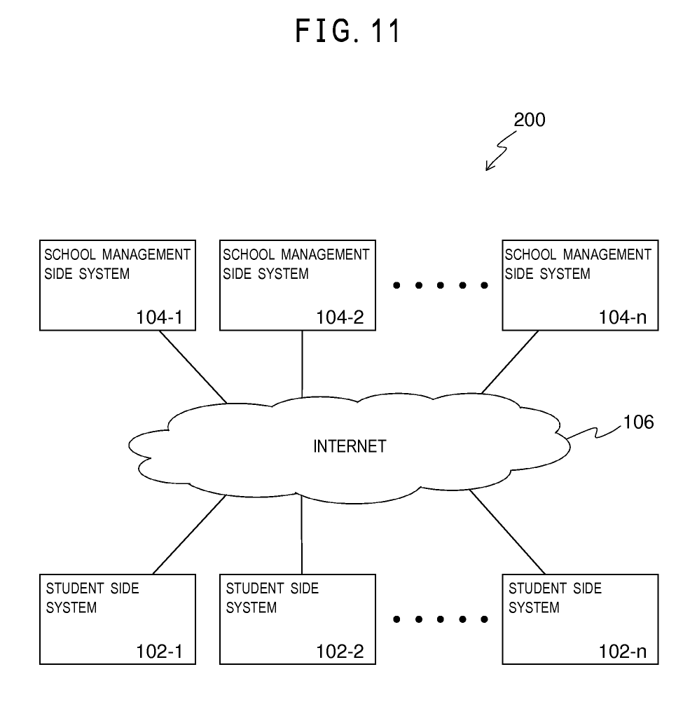

### BEST MODE FOR CARRYING OUT THE INVENTION

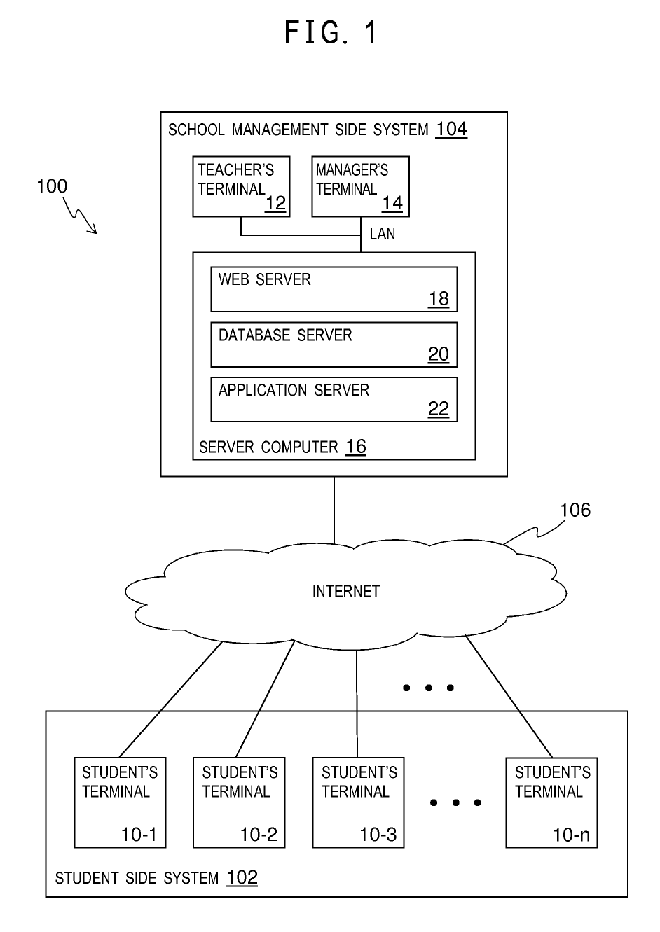

Embodiments of the present invention will be hereinafter described using the drawings. FIG. 1 shows a first embodiment of a virtual school system of the present invention. A virtual school system 100 includes a student side system 102, and a school management side system 104 connected to the student side system 102 by way of Internet 106 (second network).

The student side system 102 includes a plurality of student's terminals 10-c (c=1 to n, n; number of students attending class). Matters that apply to all the student's terminals are indicated as student's terminal 10-c below.

The school management side system 104 includes a teacher's terminal 12, a manager's terminal 14 for managing attendance etc. of students, and a server computer 16 which communicates in a wired system with the teacher's terminal 12 and the manager's terminal 14 by way of LAN (Local Area Network) (first network). The server computer 16 may communicate with the teacher's terminal 12 and the manager's terminal 14 in a wireless system complying with the IEEE (Institute of Electrical and Electronics Engineers) 802.11b of wireless LAN. The teacher's terminal 12 and the manager's terminal 14 may be connected to the server computer 16 by way of Internet.

The server computer 16 includes a web server 18 for storing a homepage of the school management side in advance; a database server 20 for storing identification information of each student (for junior high and high school students, information such as (1) name (handle name), (2) grade, (3) school name, (4) attending courses, (5) E-mail address, (6) FAX number, (7) club activity, (8) extracurricular learning of students, and in addition, (9) learning days/number of hours, (10) learning content, (11) intelligibility check, (12) HR attendance state, (13) small test result, (14) school grades (regular test, school recommendation, academic ability test) result as learning history) in correspondence to each student password; and an application server 22. The database server 20 receives the identification information from each student's terminal 10-c, and cross checks the received identification information and the identification information stored in advance.

The application server 22 collects image and voice of the teacher from the teacher's terminal 12 through the LAN. The application server 22 collects image and voice of each student from each student's terminal 10-c through the Internet 106 based on the cross check result by the database server 20. The application server 22 distributes each collected image and each voice to each student's terminal 10-c and the teacher's terminal 12, and controls each student's terminal 10-c and the teacher's terminal 12.

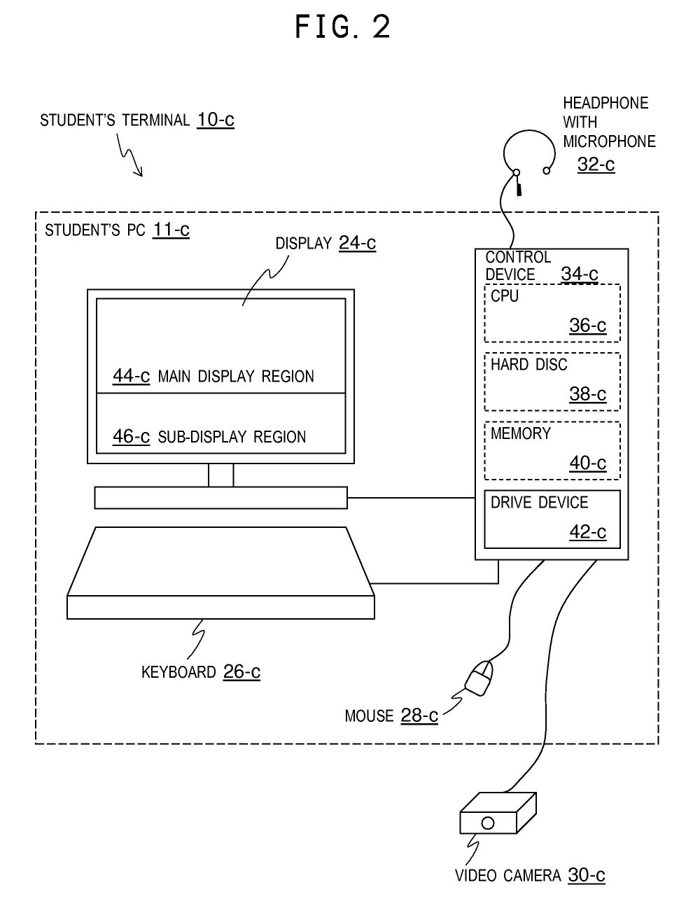

FIG. 2 shows details of the student's terminal 10-c. The student's terminal 10-c includes a student's personal computer 11-c, a video camera 30-c (student's camera), and a student's headphone with microphone 32-c (student's microphone and student's speaker).

The student's personal computer 11-c includes a display 24-c (display part for student) with a main display region 44-c and a sub-display region 46-c; a keyboard 26-c and a mouse 28-c for inputting commands, numerical values etc. from the student; and a control device 34-c. The area of the main display region 44-c may be larger than the area of the sub-display region 46-c or may be the same as the area of the sub-display region 46-c.

The control device 34-c is connected with the display 24-c, the keyboard 26-c and the mouse 28-c, the video camera 36-c, as well as the student's headphone with microphone 32-c by way of an interface circuit (not shown). The control device 34-cincludes a CPU 36-c (student information transmitting unit, student image transmitting unit, student voice transmitting unit, student display control unit, student request transmitting unit, and access request transmitting unit) for controlling each device of the student's terminal 10-c, a hard disc 38-c, a memory 40-c for temporarily storing image information and voice information, and a drive device 42-c.

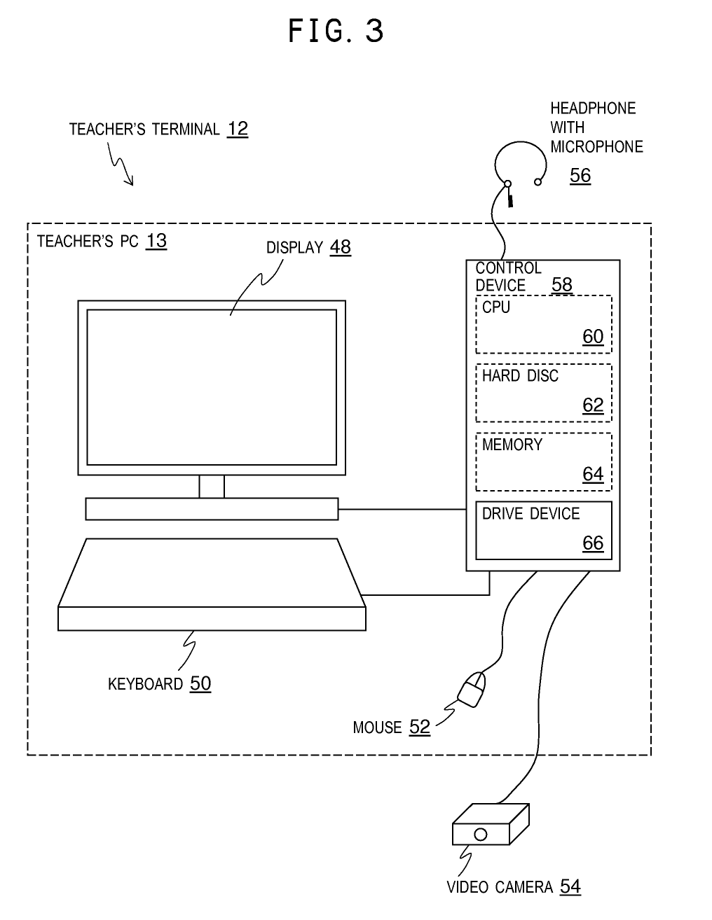

FIG. 3 shows details of the teacher's terminal 12. The teacher's terminal 12 includes a teacher's personal computer 13, a teacher's video camera 54 (teacher's camera) for imaging the image of a teacher, and a teacher's headphone with microphone 56 (teacher's microphone and teacher's speaker). The teacher's personal computer 13 includes a display 48 for displaying the image; a keyboard 50 and a mouse 52 for inputting command, numerical values etc. from the teacher; and a control device 58.

The control device 58 is connected with the display 48, the keyboard 50 and the mouse 52, the video camera 54, as well as the teacher's headphone with microphone 56 by way of an interface circuit (not shown). The control device 58 includes a CPU 60 (teacher image transmitting unit and teacher voice transmitting unit) for controlling each device of the teacher's terminal 12, a hard disc 62, a memory 64 for temporarily storing image information and voice information, and a drive device 66.

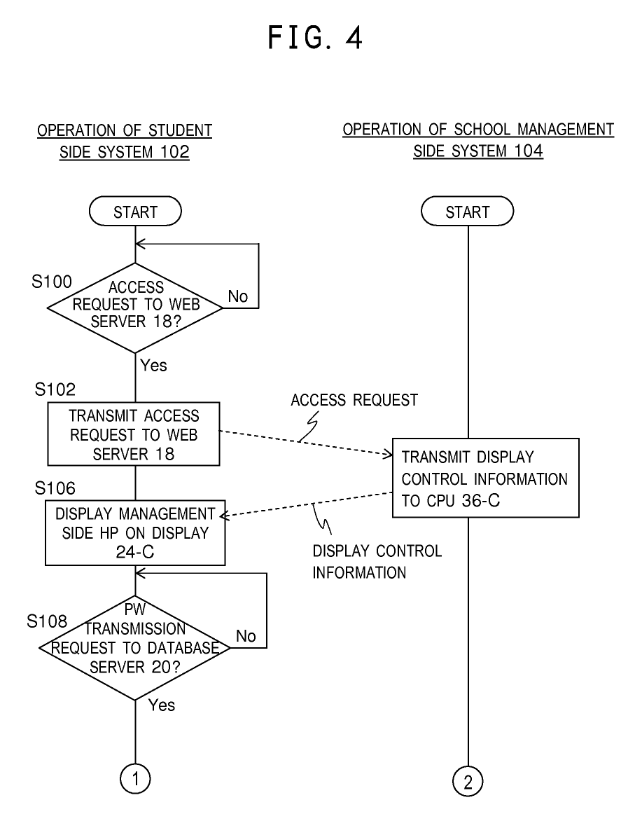

FIGS. 4 to 6 show a display operation of the virtual school system 100 according to the first embodiment. To simplify the operation description below, the number of students participating in lecture or homeroom class is assumed to be three, student 1 using the student's terminal 10-1, student 2 using the student's terminal 10-2, and student 3 using the student's terminal 10-3. In this example, each student's terminal 10-c (c=1 to 3) is connected to the server computer 16 by way of the Internet 106, and the teacher's terminal 12 is connected to the server computer 16 by way of the LAN in the initial state.

First, in step S100, the CPU 36-c waits until the keyboard 26-c or the mouse 28-c is operated by each student to start the access to the web server 18. When such operation (access request to the web server 18) is detected, the process proceeds to step S102. Step S100 is repeated until the access requests from all the students are detected.

In step S102, the CPU 36-c transmits the detected access request to the web server 18. Thereafter, the process proceeds to step S104.

In step S104, the web server 18 transmits the control information to the CPU 36-c in synchronization with the reception of the access request. Thereafter, the process proceeds to step S106.

In step S106, the CPU 36-c controls the display 24-c in synchronization with the reception of the control information, and displays the homepage (HP) of the school management side on the display 24-c. The process then proceeds to step S108.

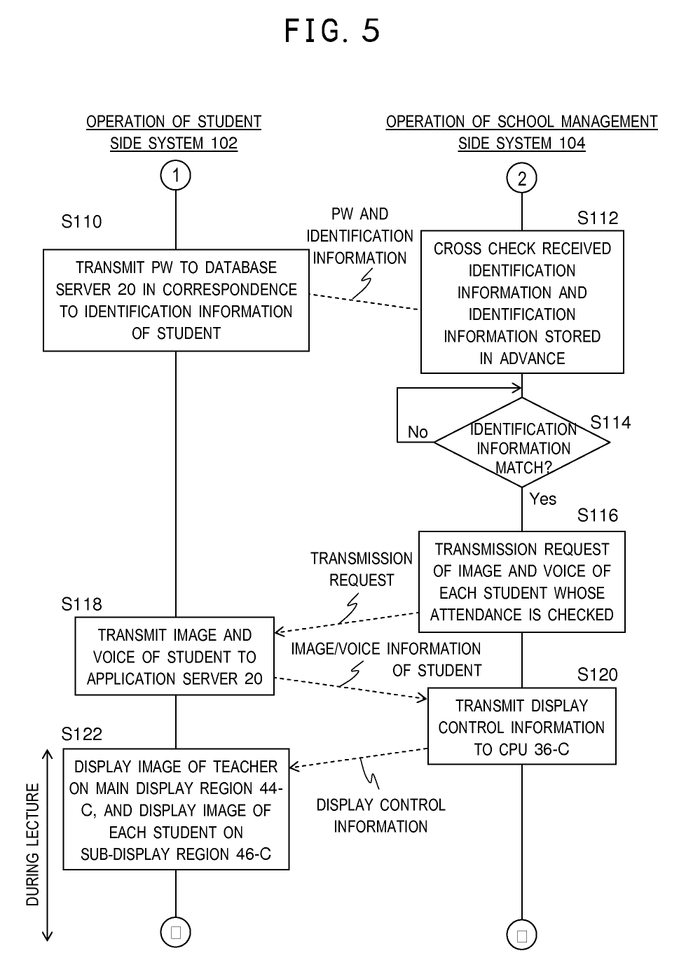

In step S108, the CPU 36-c waits until the keyboard 26-c or the mouse 28-c is operated to transmit the student password (PW) to the database server 20. When such operation (password transmission request to the database server 20) is detected, the process proceeds to step S110 (FIG. 5). Step S108 is repeated until the password transmission requests from all the students are detected.

In step S110, the CPU 36-c transmits the student password (PW) to the database server 20 in correspondence to the identification information of the student (for junior high and high school students, information such as (1) name (handle name), (2) grade, (3) school name, (4) attending courses, (5) E-mail address, (6) FAX number, (7) club activity, (8) extracurricular learning of students, and in addition, (9) learning days/number of hours, (10) learning content, (11) intelligibility check, (12) HR attendance state, (13) small test result, (14) school grades (regular test, school recommendation, academic ability test) result as learning history). The process then proceeds to step S112.

In step S112, the database server 20 receives the identification information, and cross checks the received identification information and the identification information stored in advance. The process then proceeds to step S114.

In step S114, when each identification information match (when attendance of all the students is checked), the process proceeds to step S116. If not matched (when attendance of all the students is not checked), the process repeats step S114 until the attendance of all the students (student 1, student 2, and student 3) is checked.

In step S116, the application server 22 transmits a transmission request of the image and the voice of each student to the CPU 36-c to receive the image and the voice of each student whose attendance is checked, and transmits a transmission request of the image and the voice of the teacher to the CPU 60 to receive the image and the voice of the teacher. Thereafter, the process proceeds to step S118.

In step S118, the CPU 36-c transmits image information of the student imaged in real time with the video camera 30-c and voice information of the student collected by the headphone with microphone 32-c to the application server 22 in synchronization with the reception of the transmission request of the image and the voice of each student. Similarly, the CPU 60 transmits the image information and the voice information of the teacher to the application server 22 in synchronization with the reception of the transmission request of the image and the voice of the teacher. Thereafter, the process proceeds to step S120.

In step S120, the application server 22 transmits display control information to the CPU 36-c in synchronization with the reception of the image information and the voice information of the student and the teacher to start the lecture. The application server 22 may distribute the educational material content used in the lecture. The lecture may start using the learning textbook distributed to each student in advance. Thereafter, the process proceeds to step S122.

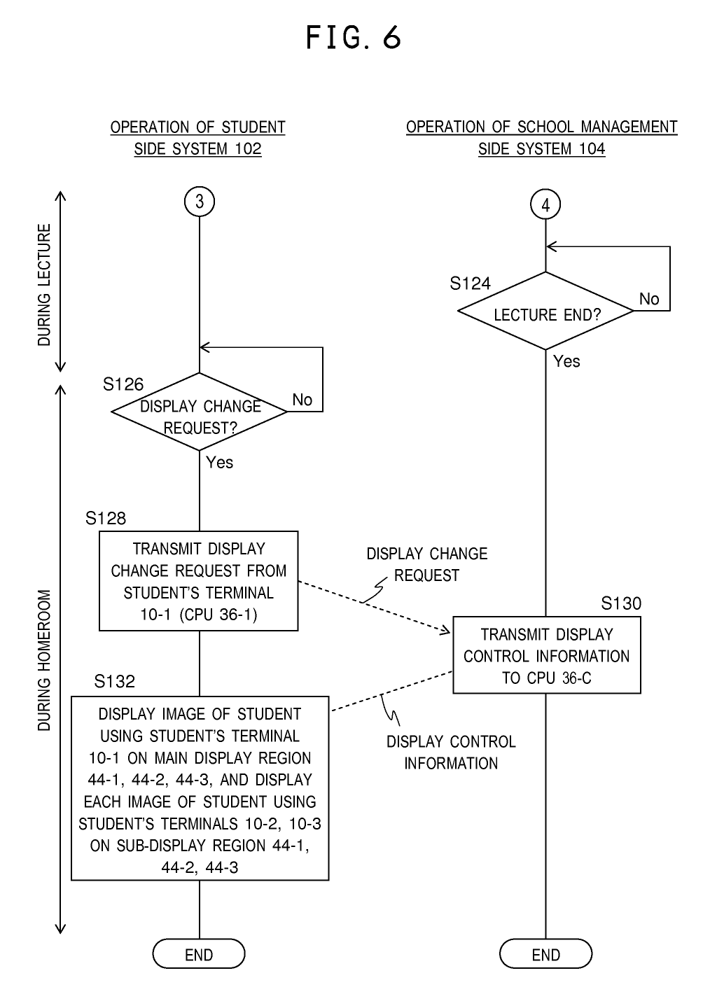

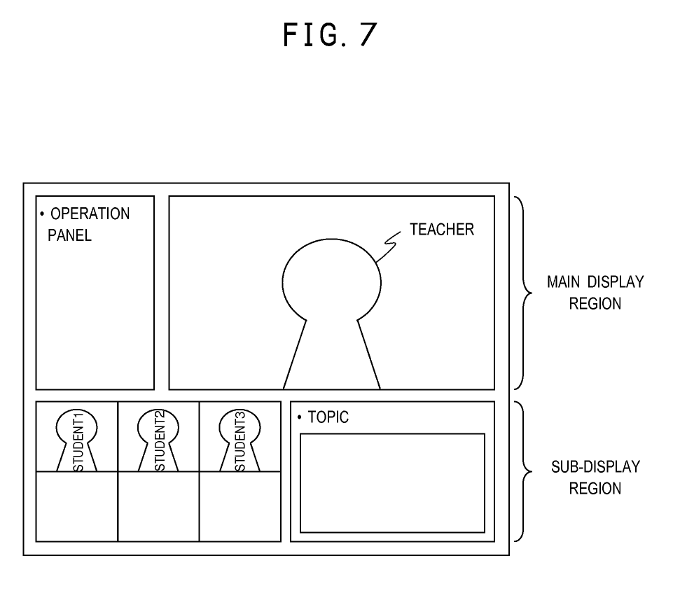

In step S122, the CPU 36-c controls the display 24-c and the display 48 in synchronization with the reception of the display control information to display the image of the teacher on the main display region 44-c and display the image of each student on the sub-display region 46-c, as shown in FIG. 7, and controls the headphone with microphone 32-c to output the voice of each student and teacher. In place of the image of the teacher and each student, the teacher may be displayed on the main display region 44-cand each student may be displayed on the sub-display region 46-c. The lecture starts by such display or output, and the process proceeds to step S124 (FIG. 6).

In step S124, the application server 22 waits until the end of lecture is detected. When the end of lecture is detected, the process proceeds to step S126 to start the homeroom class. Step S124 is repeated until the end of lecture is detected.

In step S126, the homeroom class is started, and the CPU 36-c waits until the keyboard 26-c or the mouse 28-c is operated by each student to make a request for display change of the display 24-c with respect to the application server 22. In this example, student 1 makes the individual presentation in the homeroom class and the relevant operation (display change request to the application server 22) is detected in the student's terminal 10-1 (CPU 36-1), and the process proceeds to step S128. Step S126 is repeated until the display change request is detected.

In step S128, the CPU 36-1 transmits the display change request to the application server 22. Thereafter, the process proceeds to step S130.

In step S130, the application server 22 transmits the display control information to the CPU 36-c in synchronization with the reception of the display change request. The process then proceeds to step S132.

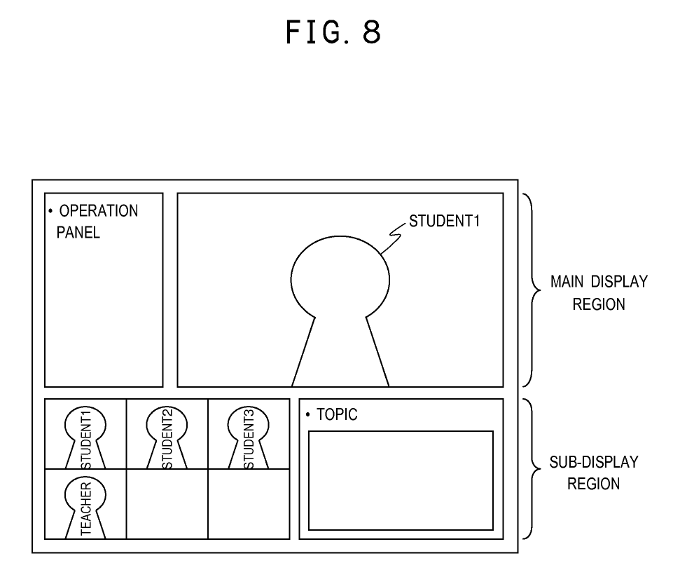

In step S132, the CPU 36-c controls the display 24-c in synchronization with the reception of the display control information to display the image of the student 1 using the student's terminal 10-1 on the main display region 44-c and display the image of students 2, 3 using the student's terminal 10-2, 10-3, respectively, on the sub-display region 46-c, as shown in FIG. 8. The image of the student 1 making the individual presentation thus may be displayed on the main display region 44-c of a larger area than the sub-display region 46-c.

Similar display may be made on the main display region 44-c and the sub-display region 46-c for the display 48 for the teacher, so that in response to the operation of the teacher's computer (e.g., when image of student 1 is clicked by the operation of the mouse 52), the information (such as intelligibility check, small test result, and school grade) of the clicked student 1 are displayed in a topic field of the sub-display region. The teacher can check the information of the student according to such display. The display operation of the virtual school system 100 according to the first embodiment is thereby terminated.

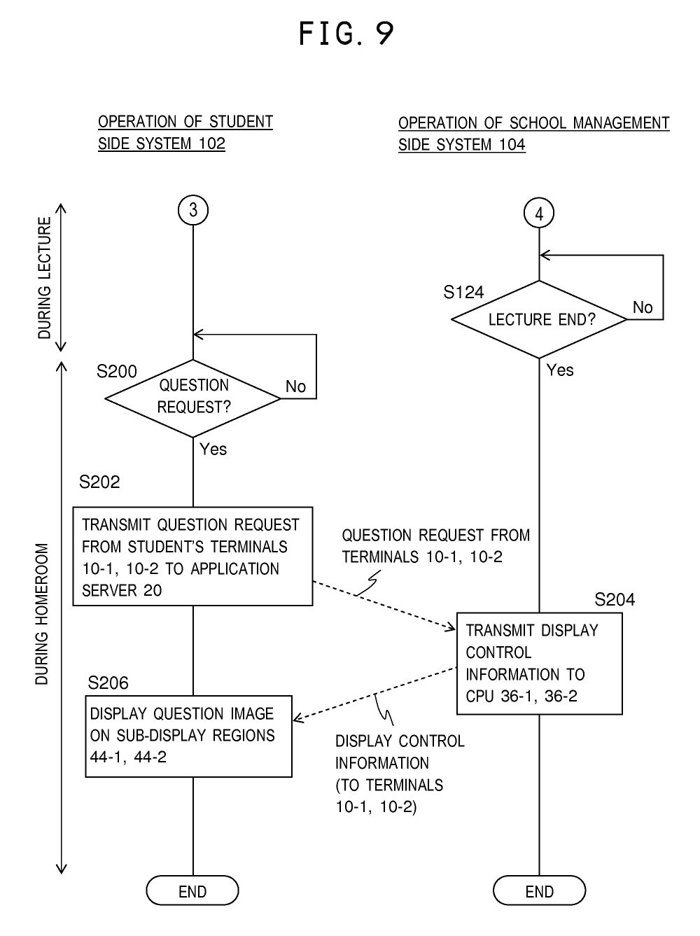

FIG. 9 shows a display operation of the virtual school system 100 according to a second embodiment of the present invention. The detailed description on the elements same as the elements described in the first embodiment is not shown. The present embodiment is the same as the first embodiment (FIGS. 4 to 6) other than that step S200 to step S206 are executed instead of step S126 to step S132 (FIG. 6) after step S124 shown in FIG. 6 is executed.

First, in step S124, the application server 22 waits until the end of lecture is detected. When the end of lecture is detected, the process proceeds to step S200 to start the homeroom class. Step S124 is repeated until the end of lecture is detected.

In step S200, the homeroom class is started, and the CPU 36-c (question request transmitting unit) waits until the keyboard 26-c or the mouse 28-c is operated by each student to transmit a question request to the application server 22. In this example, student 1 and student 2 make the question and the relevant operation (question request) is detected in the student's terminal 10-1 (CPU 36-1) and student's terminal 10-2 (CPU 36-2), and the process proceeds to step S202. Step S200 is repeated until the question request is detected.

In step S202, the CPUs 36-1, 36-2 transmit the question request to the application server 22. Thereafter, the process proceeds to step S204.

In step S204, the application server 22 transmits the display control information to the CPUs 36-1, 36-2 in synchronization with the reception of the question request. The process then proceeds to step S206.

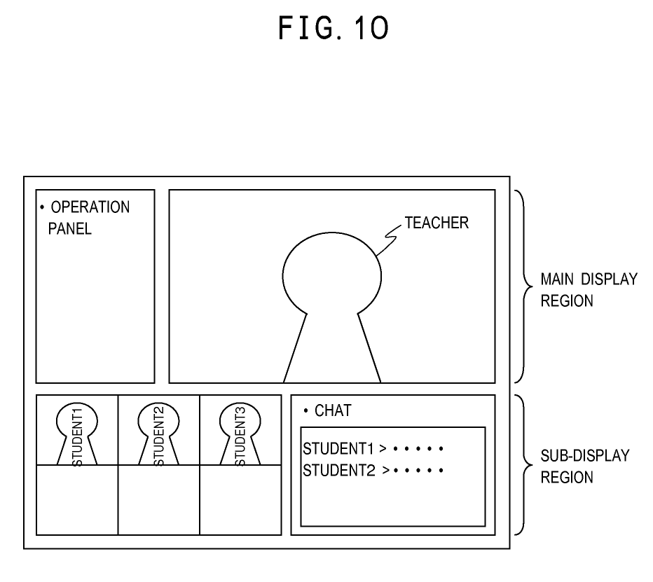

In step S206, the CPUs 36-1, 36-2 control the displays 24-1, 24-2, respectively, in synchronization with the reception of the display control information, and display the question image on the sub-display regions 46-1, 46-2, respectively, as shown in FIG. 10. Through such display, student 1 and student 2 are able to have a question-and-answer session with the teacher. An e-mail image may be displayed on the sub-display region to accept questions. In this case, questions and answers to the questions are made through E-mail, FAX, etc. The display operation of the virtual school system 100 according to the second embodiment is thereby terminated.

FIG. 10 shows one embodiment of a school city system of the present invention. The detailed description on the elements same as the elements described in the first embodiment is not shown. The present embodiment is the same as the first embodiment (FIGS. 1 to 6) other than that a school city system 200 is configured by a plurality of student side systems 102-l to 102-n and a plurality of school management side systems 104-l to 104-n connected to each other by way of the Internet 106. In this embodiment, effects similar to the first and the second embodiments can be obtained. Furthermore, in the present embodiment, a several dozen classes are assumed to be connected by way of the Internet 106, each class having ten people. Thus, the communication between students can be realized in a wider range compared to the first and the second embodiments, and the management of the virtual school can be extended. As a result, commitment to the virtual school and the school city system as well as willingness to learn of each student can be enhanced.

The present invention has been described in detail above, but the embodiments and the variants thereof are merely examples of the invention, and the present invention should not be construed as being limited thereto. Modifications can be made without departing from the scope of the invention.

### INDUSTRIAL APPLICABILITY

According to the present invention, the sense of reality as if taking classes in school can be realized using homeroom class and place to exchange information. Furthermore, the learning goal can be achieved by providing a mechanism that enhances the commitment of the student and enables students to compete and support each other.

What is claimed is:

1. A virtual school system comprising:
a school management side system including a teacher's terminal and a server computer connected to the teacher's terminal by way of a first network; and
a student side system including a plurality of student's terminals connected to the server computer by way of a second network; wherein
the teacher's terminal includes,
a teacher's personal computer,
a teacher's camera, connected to the teacher's personal computer, for imaging a teacher,
a teacher's microphone, connected to the teacher's personal computer, for inputting voice, and
a teacher's speaker, connected to the teacher's personal computer, for outputting voice;
the each student's terminal includes,
an each student's personal computer,
an each student's camera, connected to the each student's personal computer, for imaging each student,
an each student's microphone, connected to the each student's personal computer, for inputting each voice, and
an each student's speaker, connected to the each student's personal computer, for outputting each voice;
the teacher's personal computer includes,
a teacher image transmitting unit for transmitting an image of the teacher imaged by the teacher's camera to the server computer via the first network, and
a teacher voice transmitting unit for transmitting the voice of the teacher input to the teacher's microphone to the server computer via the first network;
the each student's personal computer includes,
an each student information transmitting unit for transmitting identification information of each student in correspondence to each student password to the server computer via the second network,
an each student image transmitting unit for transmitting the image of each student imaged by the each student's camera to the server computer via the second network,
an each student voice transmitting unit for transmitting the voice of each student input to the each student's microphone to the server computer via the second network;
an each student display unit with a main display region and a sub-display region, and
an each student display control unit for controlling the each student display unit;
the server computer includes,
a database server, stored in advance with identification information of each student in association with the each student password, for cross checking the identification information received from the each student information transmitting unit and the identification information stored in advance, and
an application server for receiving the image and the voice of each student from the each student image transmitting unit and the each student voice transmitting unit, receiving the image and the voice of the teacher from the teacher image transmitting unit and the teacher voice transmitting unit based on the cross check result by the database server, controlling the each student display control unit and the each student's speaker via the second network, displaying the received image of the teacher and the image of each student on the main display region and the sub-display region, respectively, and outputting the received image of the teacher and the image of each student to the each student's speaker;
the each student's personal computer includes each student request transmitting unit for receiving a display change request by operation of each student, and transmitting the display change request to the application server via the second network; and
the application server displays the image of the corresponding student on the main display region and displays the image of another student on the sub-display region when receiving the display change request from one of the each student request transmitting unit.

2. The virtual school system of claim 1, wherein
the each student's personal computer includes each access request transmitting unit for receiving an access request by operation of each student and transmitting the access request to the server computer via the second network; and
the server computer includes a web server, storing a homepage of the school management side in advance, for controlling the each student display control unit via the second network and displaying the homepage on the each student display unit when receiving each access request from the each access request transmitting unit.

3. The virtual school system of claim 1, wherein
the each student's personal computer includes each question request transmitting unit for receiving a question request by operation of each student, and transmitting the question request to the application server via the second network; and
the application server controls the corresponding each student display control unit when receiving the question request, and displays the image of the teacher and a question accepting image on the main display region and the sub-display region, respectively.

4. The virtual school system of claim 1, wherein
the identification information is at least one of student ID, preferred school of student, membership number, sex, name (handle name), name of enrolled junior high school or high school, grade, age, scholastic ability of various subjects, with respect to junior high school student, high school student, college student, and working people.

5. A school city system comprising a plurality of virtual school systems comprising:
a school management side system including a teacher's terminal and a server computer connected to the teacher's terminal by way of a first network; and
a student side system including a plurality of student's terminals connected to the server computer by way of a second network; wherein
the teacher's terminal includes,
a teacher's personal computer,
a teacher's camera, connected to the teacher's personal computer, for imaging a teacher,
a teacher's microphone, connected to the teacher's personal computer, for inputting voice, and
a teacher's speaker, connected to the teacher's personal computer, for outputting voice;
the each student's terminal includes,
an each student's personal computer,
an each student's camera, connected to the each student's personal computer, for imaging each student,
an each student's microphone, connected to the each student's personal computer, for inputting each voice, and
an each student's speaker, connected to the each student's personal computer, for outputting each voice;
the teacher's personal computer includes,
a teacher image transmitting unit for transmitting an image of the teacher imaged by the teacher's camera to the server computer via the first network, and
a teacher voice transmitting unit for transmitting the voice of the teacher input to the teacher's microphone to the server computer via the first network;
the each student's personal computer includes,
an each student information transmitting unit for transmitting identification information of each student in correspondence to each student password to the server computer via the second network,
an each student image transmitting unit for transmitting the image of each student imaged by the each student's camera to the server computer via the second network,
an each student voice transmitting unit for transmitting the voice of each student input to the each student's microphone to the server computer via the second network;
an each student display unit with a main display region and a sub-display region, and
an each student display control unit for controlling the each student display unit;
the server computer includes,
a database server, stored in advance with identification information of each student in association with the each student password, for cross checking the identification information received from the each student information transmitting unit and the identification information stored in advance, and
an application server for receiving the image and the voice of each student from the each student image transmitting unit and the each student voice transmitting unit, receiving the image and the voice of the teacher from the teacher image transmitting unit and the teacher voice transmitting unit based on the cross check result by the database server, controlling the each student display control unit and the each student's speaker via the second network, displaying the received image of the teacher and the image of each student on the main display region and the sub-display region, respectively, and outputting the received image of the teacher and the image of each student to the each student's speaker;
the each student's personal computer includes each student request transmitting unit for receiving a display change request by operation of each student, and transmitting the display change request to the application server via the second network; and
the application server displays the image of the corresponding student on the main display region and displays the image of another student on the sub-display region when receiving the display change request from one of the each student request transmitting unit.

6. The virtual school system of claim 5, wherein
the each student's personal computer includes each access request transmitting unit for receiving an access request by operation of each student and transmitting the access request to the server computer via the second network; and
the server computer includes a web server, storing a homepage of the school management side in advance, for controlling the each student display control unit via the second network and displaying the homepage on the each student display unit when receiving each access request from the each access request transmitting unit.

7. The virtual school system of claim 5, wherein
the each student's personal computer includes each question request transmitting unit for receiving a question request by operation of each student, and transmitting the question request to the application server via the second network; and
the application server controls the corresponding each student display control unit when receiving the question request, and displays the image of the teacher and a question accepting image on the main display region and the sub-display region, respectively.

8. The virtual school system of claim 5, wherein
the identification information is at least one of student ID, preferred school of student, membership number, sex, name (handle name), name of enrolled junior high school or high school, grade, age, scholastic ability of various subjects, with respect to junior high school student, high school student, college student, and working people.
